(19) United States
(12) Patent Application Publication
(10) Pub. No.: US 2010/0198666 A1
(43) Pub. Date: Aug. 5, 2010

(54) INTERNET ADVERTISING SYSTEM AND METHOD WITH AUTHENTICATION PROCESS THROUGH A MOBILE PHONE NETWORK

(76) Inventors: Chih-Ming Chiang, Taipei County (TW); Feng-Chih Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/618,773

(22) Filed: Nov. 15, 2009

(30) Foreign Application Priority Data
Feb. 3, 2009 (TW) 098103355

(51) Int. Cl. G06Q 30/00

(52) U.S. Cl. 705/14.2; 705/14.73

(57) ABSTRACT

An Internet advertising system is disclosed. A commercial project database stores a commercial, a questionnaire related to the commercial and a predetermined answer to the questionnaire. A user database stores a cellular phone number correlated to a user. A server is arranged to transmit the commercial and the questionnaire related to the commercial to a user equipment used by the user via the Internet network. An inputted answer from the user equipment via the Internet network is received and verified. The server transmits an authentication code via a cellular phone network based on the cellular phone number. An inputted code from the user equipment via the Internet network is verified for consistence.

### BACKGROUND OF THE INVENTION

1. Field of the Invention

The present invention is directed to an Internet advertising method and relevant system and, more particularly, to an Internet advertising method and relevant system that use authentication process through a mobile phone network.

2. Description of the Prior Art

For an advertiser, the value of advertising is the ability to direct a commercial to a specific group of consumers. Thus, control over the commercial in terms of when, where, how, to whom, etc., a commercial is communicated of is of paramount importance to the advertiser. Most of advertisers prefer Internet advertising to passive media, such as television, newspaper and posters, because viewers can respond to become part of the advertising message. Internet advertising is currently controlled primarily by the Internet content providers. An advertiser decides to place a commercial on a particular content provider's website with the hope that persons that access that website are potential consumers of the advertiser's product. However, there is no guarantee that this is the case. Moreover, the Internet content provider cannot provide assurance to the advertiser that a particular commercial will be directed to a specific group of consumers. It is true that Internet content providers generally do not have access to demographic data about visitors to their websites. Furthermore, the Internet content provider cannot know whether a commercial is really viewed or just skipped by the persons when visit that website. Consequently, Internet advertisers cannot ensure that their commercials are reaching a desired target audience of potential consumers and, in fact, cannot control the audience of their commercials at all.

### SUMMARY OF THE INVENTION

Embodiments of the invention disclose an Internet advertising method. A commercial and a questionnaire related to the commercial are transmitted to a user equipment via an Internet network. An inputted answer to the questionnaire from the user equipment is received via the Internet network. It is verified whether the inputted answer meets a predetermined criterion. An authentication code via a cellular phone network is transmitted to a cellular phone based on a cellular phone number correlated to a user of the user equipment. An inputted code from the user equipment is received via the Internet network. It is verified whether the inputted code is consistent with the authentication code.

Embodiments of the invention disclose an Internet advertising system, comprising a commercial project database, a user database, and a server. The commercial project database store a commercial, a questionnaire related to the commercial and a predetermined answer to the questionnaire. The user database stores a cellular phone number correlated to a user. The server is arranged to transmit the commercial and the questionnaire related to the commercial to a user equipment used by the user via the Internet network, receive an inputted answer from the user equipment via the Internet network, verify whether the inputted answer is consistent with the predetermined answer, transmit an authentication code via a cellular phone network based on the cellular phone number, receive an inputted code from the user equipment via the Internet network, and verify whether the inputted code is consistent with the authentication code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates Internet advertising management system according to an embodiment of the invention.

FIG. 2 demonstrates some interactions between an Internet advertising management system and a user.

FIG. 3 illustrates steps embodying the invention.

FIG. 4 illustrates steps for an Internet advertising management system to manage a commercial project.

FIG. 5 illustrates steps for a new user to become a member in an Internet advertising management system.

### DETAILED DESCRIPTION

To facilitate a further comprehension of objectives, characteristics and advantages of the present invention, the following paragraphs discuss embodiments in conjunction with accompanying drawings for a detailed explanation of the present invention.

An embodiment of the present invention is directed to an Internet advertising system and method that places control of Internet advertising with advertisers and ensures that Internet advertising is directed to and reaches its desired audiences. An embodiment of the invention provides motivation for the viewers to view more commercials that the website provides.

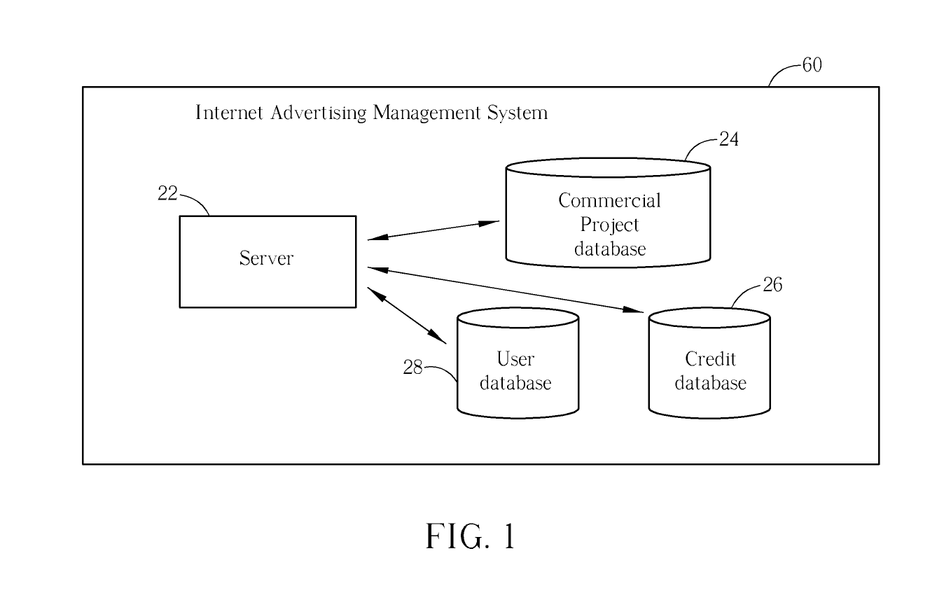

Please refer to FIG. 1, which is an illustration showing Internet advertising management system 60 according to an embodiment of the invention. An Internet advertising management system 60 may be carried out by an Internet Service Provider (ISP) or Internet portal company, using a server 22 connected to the Internet and to ISP customers. The Internet advertising management system 60 further includes a commercial project database 24, a user database 28 and a credit database 26, all of which are connected to the server 22 through a network. The commercial project database 24 records commercial projects, each defining a criterion of desired audiences and having a commercial, a questionnaire to the commercial, an answer criterion to the questionnaire, and others if needed. The commercials may include various type of information such as video, streaming video, audio, streaming audio, textual, graphic, pictorial, voice, music, links to other website, and various other information now known and hereafter developed. The questionnaire may be in forms of audio, video, graph, text, etc. The user database 28 records user information, such as gender, age, hobby, a cellular phone number, etc., that users provide for being members defined in the Internet advertising management system 60. The credit database 26 records credits that each member currently owns due to his/her interaction with the Internet advertising management system 60, and will be detailed later.

The server 22 may be a single computer or include several computers connected through an intranet or Internet network. The computer may include a central processing unit (CPU), memory devices including RAM, ROM, a hard disk unit, and a portable memory (e.g., CD-ROM, flash memory, etc.), input and output devices (e.g., keyboard, cursor-control device, printer, display), operating system software, and application specific computer program for carrying out steps embodying the invention.

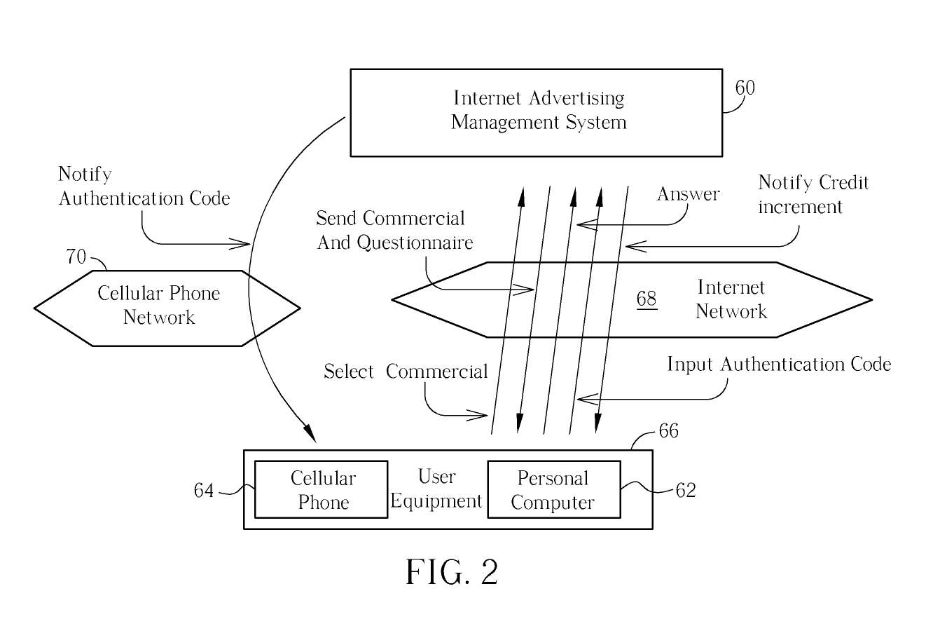

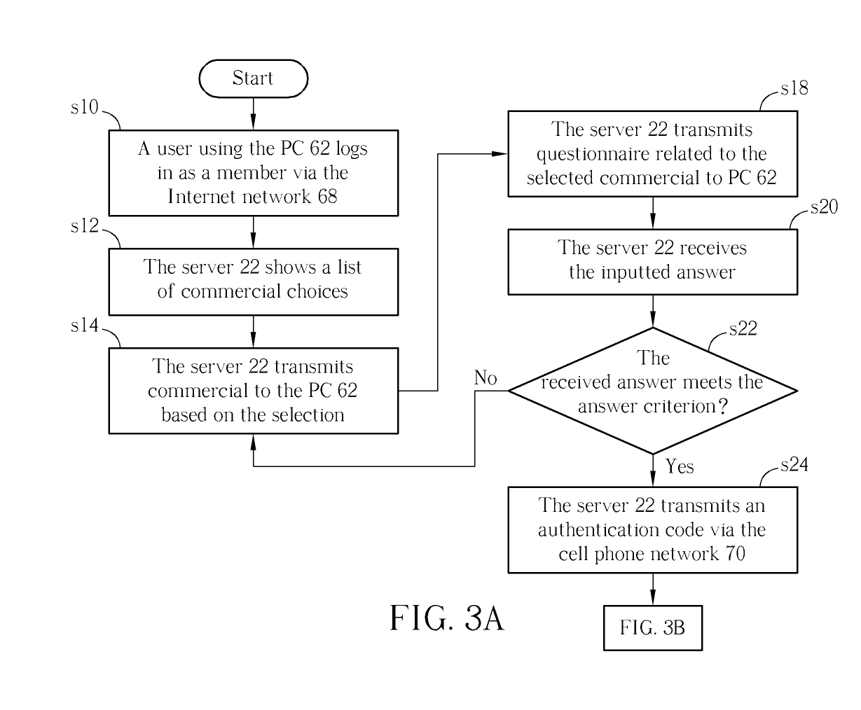

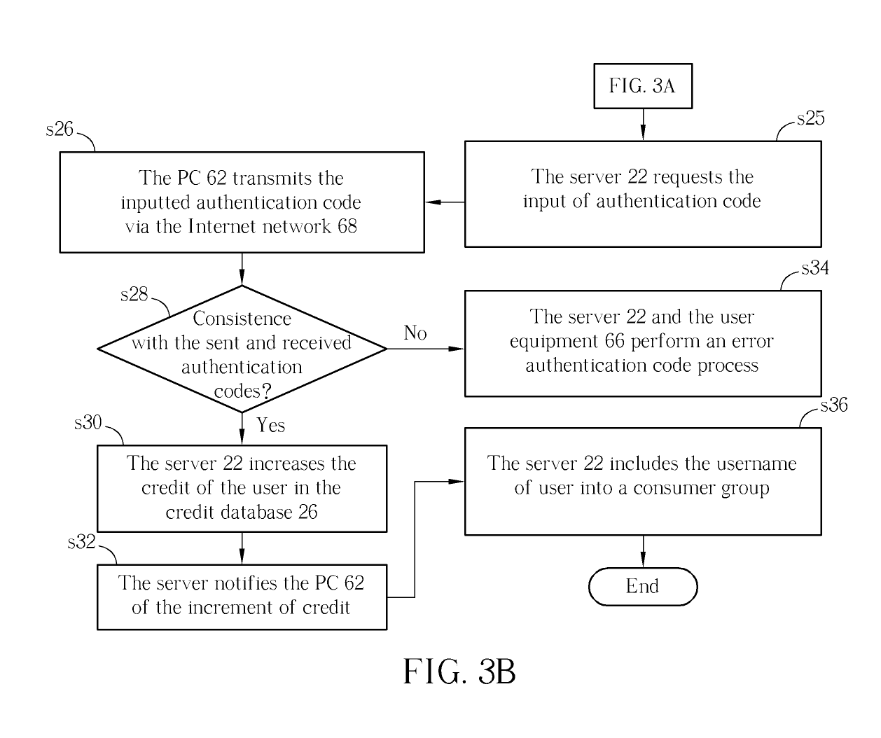

Please refer to FIGS. 2 and 3, demonstrating interactions between the Internet advertising management system 60 and a user equipment 66 that includes a personal computer (PC) 62 connected to an Internet network 68 and a cellular phone 64 connected to a cellular phone network 70, according to an embodiment of the invention. In step s10, the PC 62 accesses a website provided by the server 22 so that a user of the PC 62 logs in as a member of the Internet advertising management system 60, using a username and passwords. In step s12, the server 22 shows on a website a list of commercial choices each linking to a commercial available for a user of the PC 62 to view. The list may be generated according to personal information of the user of the PC 62. The personal information can be recorded in the user database 28 of FIG. 1 and in the criterion of desired audiences in the commercial project database 24 of FIG. 1. Through the Internet network 68, the PC 62 selects one commercial choice on the list. In step s14, in response to the selection, the server 22 transmits the selected commercial to the PC 62, and thereby the user can view or hear the selected commercial on an output device of the PC 62, such as display or loudspeaker. To ensure that the selected commercial has really been viewed or acknowledged by the user, the questionnaire stored in commercial project database 24 of FIG. 1 and correlated to the content of the selected commercial is transmitted to the PC 62 through Internet network 68, as shown in step s18. In step s20, the answer inputted to the questionnaire is then transmitted from the PC 62 to the server 22 through the Internet network. In step s22, the server 22 verifies whether the answer from the PC 62 meets the answer criterion defined in the commercial project database 24 of FIG. 1. For example, the answer criterion may be met if 80% of the inputted answer is correct. If the answer criterion is not met, steps s14, s18, s20, s22 are interacted such that the same selected commercial is re-transmitted to the PC 62 for being reviewed, and that the newly inputted answer from the PC 62 is verified. If the answer criterion is met, the interaction stops, and the server 22 assumes that the user of the PC 62 has actually viewed the selected commercial.

Credit that can be used for on-line commercial transaction is planned to give to the user as reward of viewing a commercial. Nevertheless, the user on the Internet (the user using the PC 62) may be a fake, who stole the username and passwords of a member. To verify if the user on the internet is really the one that registered to be a member, the server 22, referencing the username, retrieves his/her cellular phone number from the user database 28 (of FIG. 1), and transmits an authentication code in various forms of information such as voice, voice mail, short message service, etc., through the cellular phone network 70 to the cellular phone 64, as shown in step s24. In step s25, via the Internet network 68, the server 22 then requests the user on the internet to input, to the PC 62, the authentication code that should have been known from the cellular phone 64. If the user of the PC 62 is a real member, the user can obtain the correct authentication code sent by the server 22. On the contrary, if the user of the PC 62 is a fake, the user cannot know the authentication code since the user does not own the cellular phone 64. In step s26, the user inputs an authentication code, and the PC 62 transmits the inputted authentication code to the server 22 for the verification in step s28. If the authentication code received by the server 22 is consistent with the one sent to the cellular phone 64, the credit recorded in the credit database 26 for the user is increased, as shown in step s30. The commercial project recorded in the commercial project database 24 may rule the amount of credit increment. Step s32 follows for the server 22 to notify the PC 62 of the increment of the credit, through the Internet network. In step s36, the server 22 causes the user to become one in a consumer group defined by the owner of the commercial. Which consumer group a viewer of a commercial belongs to may be defined in a commercial project. For example, if the viewed commercial is owned by an advertiser and concerns a sport car, the username of the user is then included in a sport-car-lover group under the advertiser. The usage of the consumer group will be detailed later.

If the authentication code received by the server 22 is not consistent with the one that is previously sent to the cellular phone, an error authentication code process in step s34 is performed between the server 22 and the user equipment 66. The error authentication code process may include, for example, limited times of interaction of both transmitting authentication code through the cellular phone network 70 and verifying the authentication code received by the server 22. If, finally, the user on the Internet is deemed to be a fake one, warning notice of fault representation may be sent to the cellular phone 64 of which the cellular phone number is recorded in the user database 28 (of FIG. 1).

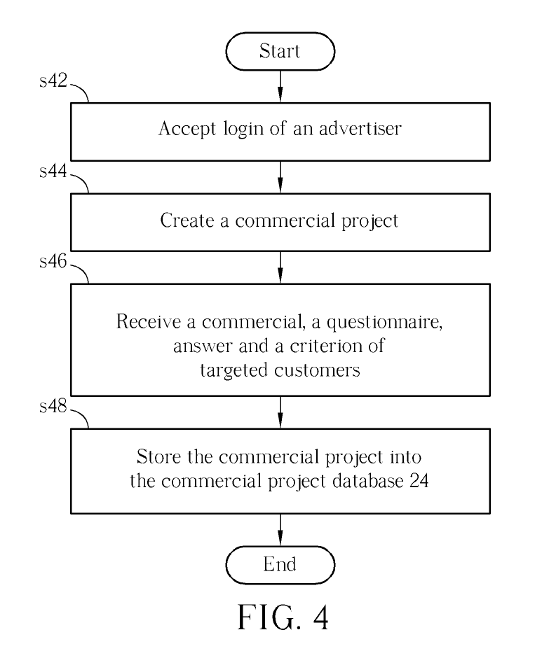

FIG. 4 illustrates steps for the Internet advertising management system 60 to manage a commercial project. The Internet advertising management system 60 may provide a website for advertisers to log in and manage their own commercial projects. Upon the receiving of an advertiser's account name and predetermined passwords, the Internet advertising management system 60 may recognize the log-in of the advertiser, as shown in step s42. In step s44, the advertiser may create a new commercial project in the commercial project database 24. A commercial, a questionnaire to the commercial, and an answer criterion to the questionnaire, as elements required in a commercial project, are uploaded in step s46 by the advertiser to the Internet advertising management system 60, which stores these elements in the commercial project database 24 in step s48. The total credit allowed to be awarded to users and the duration for a commercial to be viewed may be limited and defined in a commercial project. A commercial project may further define which consumer group a viewer of the corresponding commercial joins after the abovementioned authentication has been done. Somewhere in the Internet advertising management system 60, an advertiser is allowed to keep and manage a record of the consumer group(s), each showing those users that have viewed certain commercials. To target a specific group of consumers, the advertiser may further define and store in a commercial project a criterion of desired audiences. For example, an advertiser may define a criterion that her commercial can only be viewed by those over 18 years old.

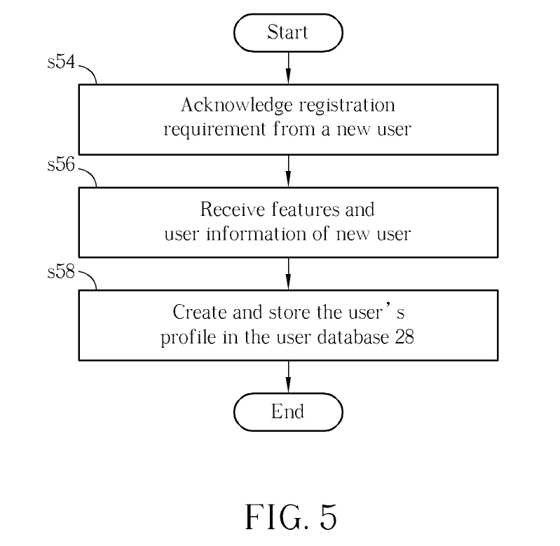

To have effective advertising, user information should be known or recorded in the Internet advertising management system 60. FIG. 5 illustrates steps for a new user to become a member of the Internet advertising management system 60. In step s54, through the Internet network 68, the Internet advertising management system 60 acknowledges the registration requirement of a new user. The Internet advertising management system 60 may render to display a website with forms for the new user to fill in with related user information. The user information required may include, but is not limited to, username, passwords, cellular phone number, age, gender, location, nationality, hobby, formal identification, etc.. Upon the receiving of the required user information in step s56, the Internet advertising management system 60 determines that the user is a new member and then creates and stores into the user database 28 a user profile with the received user information as shown in step s58. The cellular phone number may be systematically defined to be the username for a user to log in the Internet advertising management system 60.

With the user information in the user database 28 and the criterion of desire audiences in the commercial project database 24, an advertiser can assure that the commercial is effectively accessed by those targeted. For example, the list shown in step s12 of FIG. 3A can be designed to link to a commercial only if the user information of the user using the user equipment 66 (stored in the user database 28 of FIG. 1) meets the criterion of desired audiences of the commercial. By this way, a commercial can be only transmitted to those users meeting the criterion defined by an advertiser.

Credit can be used by users for on-line transaction. For example, a user may spend his/her credit on purchasing a product or a valued-added service solicited in a website that the Internet advertising management system 60 links the user to. The credit is decreased upon recognition of a complete on-line transaction rendered by the user. Thus, credit provides motivation for users to view more commercials and to answer related questionnaires. In addition to generally-known service fee, the Internet Service Provider that carries out the Internet advertising management system 60 may bill an advertiser according to the total amount of credit awarded to the audiences of a commercial.

As for setting rules in a commercial project, an identification of a viewer may be automatically included into different consumer groups managed by a corresponding advertiser. For example, an advertiser may establish and manage a sport-car-lover group and a truck-user group, and a sport car commercial project defined by the advertiser rules that a viewer of corresponding sport-car commercial will have his/her identification automatically included in the sport-car-lover group. Similar to demography, these consumer groups provide the advertiser with lists of targeted consumers in future marketing projects. For example, an advertiser may send short message with marketing information of a new sport car to the cellular phones of users whose identifications are listed in the sport-car-lover group, and the users may be rewarded with some credit upon the receiving of the short message.

In the exemplified embodiment of the invention, the PC 62, which generally provides a means to access the Internet network 68, may be replaced by any other means having similar capability of Internet network access. Furthermore, the PC 62 may be omitted if cellular phone 64 can access both the Internet network 68 and the cellular phone network 70.

Those skilled in the art will readily observe that numerous modifications and alterations of the device and method may be made while retaining the teachings of the invention.

What is claimed is:

1. An Internet advertising method comprising:
transmitting a commercial and a questionnaire related to the commercial to a user equipment via an Internet network;
receiving an inputted answer to the questionnaire from the user equipment via the Internet network;
verifying whether the inputted answer meets a predetermined criterion;
transmitting an authentication code via a cellular phone network based on a cellular phone number correlated to a user of the user equipment when the inputted answer meets the predetermined criterion;
receiving an inputted code from the user equipment via the Internet network; and verifying whether the inputted code is consistent with the authentication code.

2. The Internet advertising method of claim 1, further comprising:
including an identification of the user into a consumer group after the step of verifying whether the inputted code is consistent with the authentication code.

3. The Internet advertising method of claim 1, further comprising:
increasing credit related to the user when the inputted code is consistent with the authentication code.

4. The Internet advertising method of claim 3, further comprising:
linking an Internet website, associated with spending of the credit about on-line transaction, to the user equipment.

5. The Internet advertising method of claim 1, further comprising:
providing an Internet website for the user equipment;
receiving user information from the user equipment, wherein the user information includes the cellular phone number; and
determining that the user is registered as a member according to the received user information.

6. The Internet advertising method of claim 1, further comprising:
storing a commercial project with the commercial, the questionnaire, and a criterion of desired audiences; and
transmitting the commercial to the user equipment when user information of the user meets the criterion of desired audiences.

7. An Internet advertising system comprising:
a commercial project database for storing a commercial, a questionnaire related to the commercial and a predetermined answer to the questionnaire;
a user database for storing a cellular phone number correlated to a user;
a server arranged to transmit the commercial and the questionnaire related to the commercial to a user equipment used by the user via the Internet network, receive an inputted answer from the user equipment via the Internet network, verify whether the inputted answer is consistent with the predetermined answer, transmit an authentication code via a cellular phone network based on the cellular phone number, receive an inputted code from the user equipment via the Internet network, and verify whether the inputted code is consistent with the authentication code.

8. The Internet advertising system of claim 7, further comprising:
a credit database for storing a credit correlated to the user;
wherein the server is further arranged to increase the credit when the inputted answer is consistent with the authentication code.

9. The Internet advertising system of claim 8, wherein the server is further arranged to link a website to the user equipment for executing on-line transaction, and the credit is decreased upon recognition of a complete on-line transaction rendered by the user equipment.

10. The Internet advertising system of claim 7, wherein the server is further arranged to provide a website for the user equipment, receive user information from the user equipment, and determine that the user is registered as a member according to the received user information, wherein the user information includes the cellular phone number and is stored in the user database.
